(19) United States
(12) Patent Application Publication
(10) Pub. No.: US 2026/0048695 A1
(43) Pub. Date: Feb. 19, 2026

(54) CABIN AND MOBILE BODY INCLUDING THE SAME

(71) Applicants: Hyundai Motor Company, Seoul (KR); Kia Corporation, Seoul (KR)

(72) Inventors: Kyung Min Kim, Hwaseong-si (KR); Joo Young Chun, Hwaseong-si (KR); Hun Keon Ko, Hwaseong-si (KR)

(21) Appl. No.: 18/966,976

(22) Filed: Dec. 3, 2024

(30) Foreign Application Priority Data
Aug. 14, 2024 (KR) 10-2024-0109332

(51) Int. Cl. B60P 1/64

(52) U.S. Cl. CPC B60P 1/6409; B60P 1/6427

(57) ABSTRACT

An embodiment cabin includes a housing having an accommodation space capable of accommodating an object, a tray configured to be loaded into or unloaded from the accommodation space, wherein the object is able to be seated on the tray, a door configured to open/close the accommodation space to/from an outside of the housing, a motor fixed to the housing for generating rotational power; and a power provision part for receiving the rotational power from the motor and transmitting power to the door and the tray, the power provision part including a door driving part connecting the motor and the door and transmitting first rotational power to the door, a power conversion part connected to the motor and configured to convert second rotational power into rectilinear power, and a tray driving part configured to connect the power conversion part and the tray and transmit the rectilinear power to the tray.

### CROSS-REFERENCE TO RELATED APPLICATIONS

This application claims the benefit of Korean Patent Application No. 10-2024-0109332, filed on August 14, 2024, which application is hereby incorporated herein by reference.

### TECHNICAL FIELD

The present disclosure relates to a cabin and a mobile body including the same.

### BACKGROUND

Recently, various types of mobile objects have been developed and have substituted for human labor. Among other things, particularly, with the growth of the delivery industry, there is a trend toward developing mobile objects capable of delivering food, items, or the like in an unmanned manner.

The mobile body is configured by coupling a cabin, which has an accommodation space in which food, items, or the like may be accommodated, and a movable part coupled to the cabin and configured to move the cabin. The cabin has a tray on which the item accommodated in the accommodation space is seated and a door configured to selectively open or close the accommodation space.

In the related art, a user unloads an item from the accommodation space or loads an item into the accommodation space by manually unloading the item, which is seated on the tray, from the accommodation space or manually loading the item into the accommodation space. Meanwhile, in case that the user manually unloads the item from the accommodation space as described above, the user's arm comes into contact with the door, or the user's center of gravity is biased forward, which causes a problem in that the user drops the item. Furthermore, because the user needs to bend down to check the accommodation space in the cabin, there is a problem in that the convenience deteriorates, and it is difficult for the user with weak joints to use the cabin.

### SUMMARY

Embodiments of the present disclosure can provide a cabin having a structure in which an operation of opening a door and an operation of unloading a tray from an accommodation space may be performed in conjunction with each other.

One embodiment of the present disclosure provides a cabin including a housing having an accommodation space capable of accommodating an object therein, a tray configured to be loaded into or unloaded from the accommodation space, the tray being configured such that the object is seated on the tray, a door configured to open the accommodation space to the outside of the housing or close the accommodation space from the outside of the housing, a motor fixed to the housing and configured to generate rotational power, and a power provision part configured to receive the rotational power from the motor and transmit power, which is required for an operation of opening or closing the door and required for an operation of loading or unloading the tray, to the door and the tray. The power provision part includes a door driving part configured to connect the motor and the door and transmit first rotational power, which is any one part of the rotational power, to the door, a power conversion part connected to the motor and configured to convert second rotational power, which is another part of the rotational power, into rectilinear power, and a tray driving part configured to connect the power conversion part and the tray and transmit the rectilinear power, which is transmitted from the power conversion part, to the tray.

In addition, the door driving part may include a first region having one end configured to rotate about a first rotation axis that is an imaginary straight line extending in a first direction and the other end configured to revolve around the first rotation axis, a second region extending in a second direction that is a direction intersecting a direction in which one end of the first region and the other end of the first region are directed toward each other, the second region being fixed to the first region, and a third region having one end fixed to the door and the other end connected to the second region and configured to be movable in the second direction.

In addition, the first direction may be an upward/downward direction, the third region may intersect a reference straight line, which is an imaginary straight line passing through the first rotation axis and extending in the second direction, when a lower portion of the cabin is viewed in parallel with the upward/downward direction, a door guide hole may be formed in a lower portion of the housing and guide a movement of the other end of the third region, an imaginary curved line extending along a route along which the other end of the first region is movable may be a first curved line, the first curved line may have an arc shape having a center, which is the first rotation axis, and having a predetermined radius, and the door guide hole may include an inner section positioned to be closer to a side of the first curved line based on a radially inward direction than the first curved line and an outer section positioned to be closer to a side of the first curved line based on a radially outward direction than the first curved line.

In addition, the inner section may be provided as a plurality of inner sections, and the plurality of inner sections may include a first inner section connected to one end of the outer section and a second inner section connected to the other end of the outer section.

In addition, the third region may include a third-first region configured to define one end of the third region and extending in the second direction and a third-second region extending from the third-first region in a third direction that is a direction intersecting the second direction and a direction of the first rotation axis, and a region of the third-second region, which faces the second region, may extend in the second direction so as to be movable in the second direction relative to the second region and engage with the second region.

In addition, the tray driving part may be fixed to the tray and configured to move relative to the housing in a loading/unloading direction of the tray. The door driving part may include a first region configured to be rotated about a first rotation axis, which is an imaginary straight line extending in a first direction, by the first rotational power, and the power conversion part may be configured to be rotated about the first rotation axis by the second rotational power. A tray protrusion may be formed on the tray driving part and have a shape protruding in the first direction, a long hole may be penetratively formed in the power conversion part in the first direction and extending in a long hole direction intersecting the first direction and the loading/unloading direction, and the tray protrusion may be inserted into the long hole.

In addition, a tray guide hole may be formed in the housing and guide a movement of the tray driving part in the loading/unloading direction, one end of the power conversion part may be configured to rotate about the first rotation axis, the other end of the power conversion part may be configured to revolve around the first rotation axis, a direction of the loading/unloading direction in which the tray is unloaded from the accommodation space may be an unloading direction, a direction opposite to the unloading direction may be a loading direction, and a first distance, which is a spacing distance in the loading/unloading direction between one end of the power conversion part and an end of the tray guide hole based on the loading direction, and a second distance, which is a spacing distance in the loading/unloading direction between one end of the power transmission part and an end of the tray guide hole based on the unloading direction, may be different from each other.

In addition, the second distance may be longer than the first distance.

In addition, the power provision part may be provided as a plurality of power provision parts, a reference plane may be an imaginary plane passing through a center of the accommodation space and perpendicular to a reference direction perpendicular to an upward/downward direction and a direction in which the tray is loaded or unloaded, the plurality of power provision parts may include first and second power provision parts provided symmetrically with respect to the reference plane, the rotational power generated by the motor may be transmitted only to any one of the first power provision part and the second power provision part, and the cabin may further include a power transmission part configured to transmit a part of the rotational power, which is transmitted to any one of the first and second power provision parts, to the other of the first and second power provision parts.

In addition, the power transmission part may include a first gear configured to be rotated about a first rotation axis by the motor and fixed to the door driving part and the power conversion part provided in the first power provision part, a second gear fixed to the door driving part and the power conversion part provided in the second power provision part, and an intermediate gear configured to engage with the first gear and the second gear to transmit rotational power of the first gear to the second gear.

In addition, the tray driving part may further include a belt member and a rotary member tightly attached to the belt member and configured to be rotatable. One side of the belt member may be fixed to the housing, and the other side of the belt member may be fixed to the tray.

In addition, the housing may include a lower plate provided in a lower region of the cabin, the lower plate may be provided to face the tray in an upward/downward direction, and one side of the belt member may be fixed to the lower plate.

In addition, one side of the belt member may be formed in an upper region based on the rotary member, and the other side of the belt member may be formed in a lower region based on the rotary member.

In addition, another embodiment of the present disclosure provides a mobile body including a cabin and a movable part configured to move the cabin, in which the cabin includes a housing having an accommodation space capable of accommodating an object therein, a tray configured to be loaded into or unloaded from the accommodation space, the tray being configured such that the object is seated on the tray, a door configured to open the accommodation space to the outside of the housing or close the accommodation space from the outside of the housing, a motor fixed to the housing and configured to generate rotational power, and a power provision part configured to receive the rotational power from the motor and transmit power, which is required for an operation of opening or closing the door and required for an operation of loading or unloading the tray, to the door and the tray. The power provision part includes a door driving part configured to connect the motor and the door and transmit first rotational power, which is any one part of the rotational power, to the door, a power conversion part connected to the motor and configured to convert second rotational power, which is another part of the rotational power, into rectilinear power, and a tray driving part configured to connect the power conversion part and the tray and transmit the rectilinear power, which is transmitted from the power conversion part, to the tray.

The mobile body according to embodiments of the present disclosure has the structure in which the operation of opening the door and the operation of unloading the tray from the accommodation space may be performed in conjunction with each other, such that it is possible to prevent the user from dropping the item while the user unloads the item from the accommodation space.

In addition, the mobile body according to embodiments of the present disclosure has the structure capable of allowing the user to check the accommodation space in the cabin without bending down, such that it is possible to improve the convenience, and it is easy for the user with weak joints to use the mobile body.

### BRIEF DESCRIPTION OF THE DRAWINGS

FIG. 1 is a perspective view of a mobile body when doors according to an embodiment of the present disclosure are in a closed state.

FIG. 2 is a bottom plan view of a cabin when the doors according to an embodiment of the present disclosure are in the closed state.

FIG. 3 is a view illustrating a power provision part when the doors according to an embodiment of the present disclosure are in the closed state.

FIG. 4 is a view illustrating the power provision part when the doors according to an embodiment of the present disclosure switch from the closed state to an opened state.

FIG. 5 is a view illustrating the power provision part when the doors according to an embodiment of the present disclosure are in the opened state.

FIG. 6 is a perspective view of the cabin when the doors according to an embodiment of the present disclosure are in the opened state.

FIG. 7 is a bottom plan view of the cabin when the doors according to an embodiment of the present disclosure are in the opened state.

FIG. 8 is a cross-sectional view for explaining coupling structures between a tray, a tray driving part, and a housing according to an embodiment of the present disclosure, i.e., a view illustrating a state made before the tray driving part is moved forward.

FIG. 9 is a cross-sectional view for explaining the coupling structures between the tray, the tray driving part, and the housing according to an embodiment of the present disclosure, i.e., a view illustrating a state made after the tray driving part is moved forward.

### DETAILED DESCRIPTION OF ILLUSTRATIVE EMBODIMENTS

Hereinafter, some embodiments of the present disclosure will be described in detail with reference to the illustrative drawings. In giving reference numerals to constituent elements of the respective drawings, it should be noted that the same constituent elements will be designated by the same reference numerals, if possible, even though the constituent elements are illustrated in different drawings. Further, in the following description of the embodiments of the present disclosure, a detailed description of related publicly known configurations or functions will be omitted when it is determined that the detailed description obscures the understanding of the embodiments of the present disclosure.

Hereinafter, a mobile body 1 according to embodiments of the present disclosure will be described with reference to the drawings.

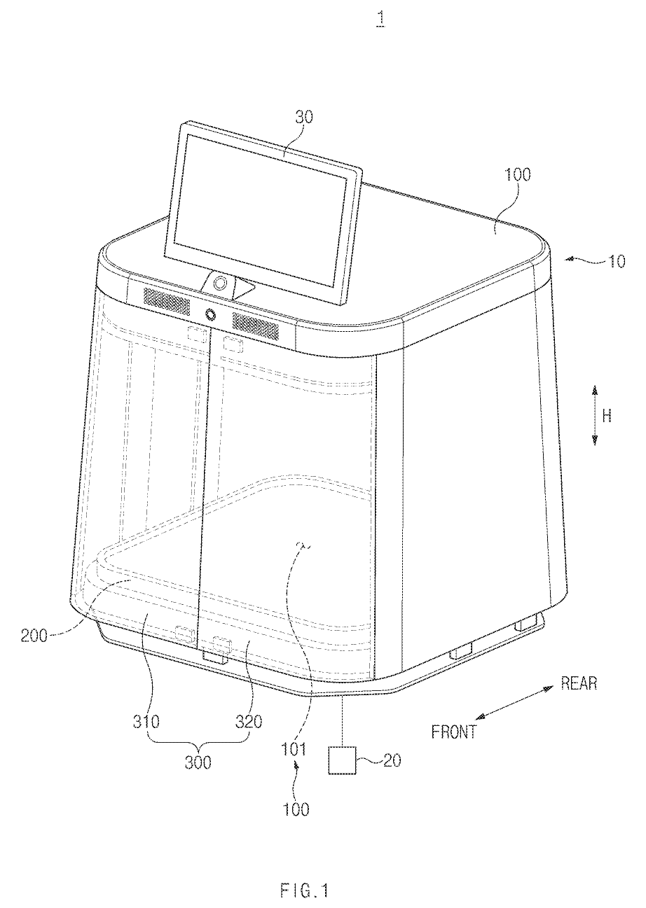

FIG. 1 is a perspective view of the mobile body when doors according to an embodiment of the present disclosure are in a closed state.

With reference to FIG. 1, the mobile body 1 may refer to various structures capable of moving using a movable part such as a wheel or a propeller. For example, the mobile body 1 may be provided as a vehicle, a drone, or the like. The mobile body 1 may include a cabin 10, a movable part 20, and a display part 30.

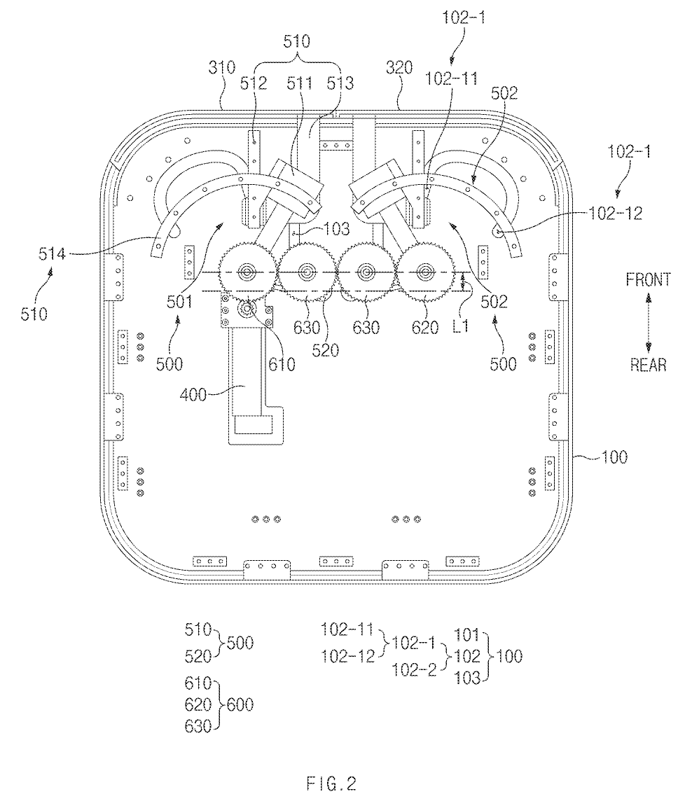

FIG. 2 is a bottom plan view of the cabin when the doors according to an embodiment of the present disclosure are in the closed state.

With reference to FIG. 2, the cabin 10 may accommodate an item and store or transport the accommodated item. The cabin 10 may be selectively mounted on the movable part 20. The cabin 10 may include a housing 100, a tray 200, doors 300, a motor 400, power provision parts 500, and a power transmission part 600.

The housing 100 may define an external appearance of the cabin 10. For example, the housing 100 may have a shape having a horizontal width that decreases upward. An accommodation space 101, door guide holes 102, and tray guide holes 103 may be formed in the housing 100.

The accommodation space 101 may be formed in the housing 100. The accommodation space 101 may accommodate items (e.g., parcel delivery items, food, and the like). The door guide hole 102 may be penetratively formed in a lower portion of the housing 100 in an upward/downward direction H. The door guide hole 102 may guide a motion of the door 300 relative to the housing 100. For example, the door guide hole 102 may have a horseshoe shape.

In addition, the door guide holes 102 may be provided as a plurality of door guide holes 102. The plurality of door guide holes 102 may be disposed to be spaced apart from one another in a leftward/rightward direction. For example, the plurality of door guide holes 102 may have a symmetric shape with respect to a reference plane that is an imaginary plane passing through a center of the housing 100 and perpendicular to the leftward/rightward direction. The door guide hole 102 may include inner sections 102-1 and an outer section 102-2.

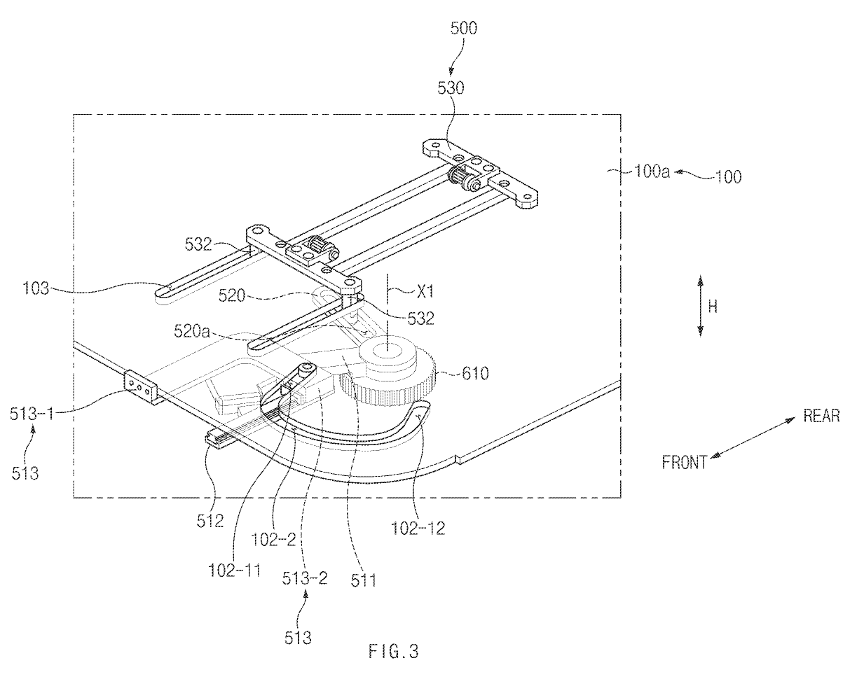

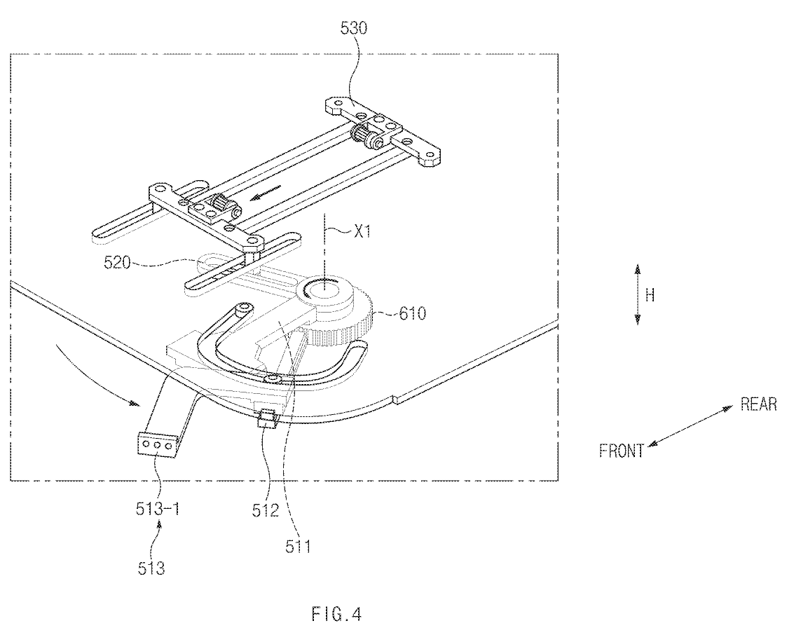

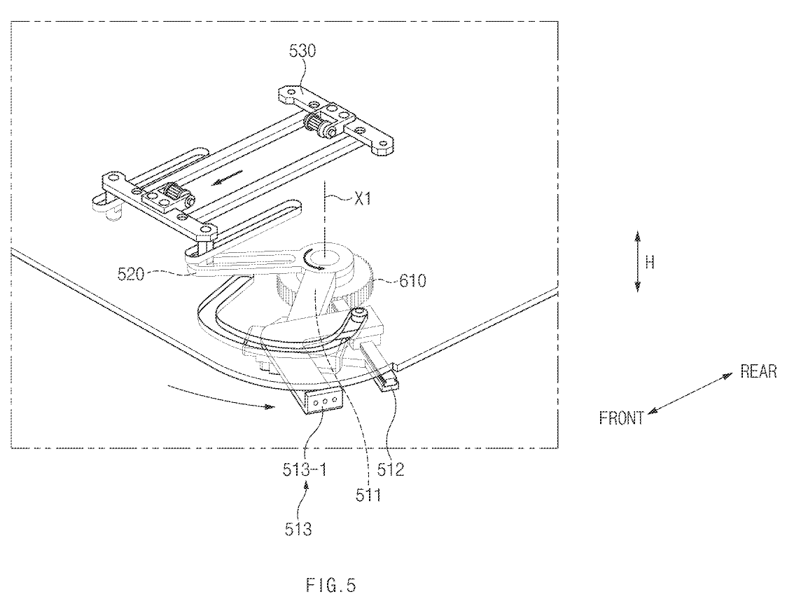

FIG. 3 is a view illustrating the power provision part when the doors according to an embodiment of the present disclosure are in the closed state, FIG. 4 is a view illustrating the power provision part when the doors according to an embodiment of the present disclosure switch from the closed state to an opened state, and FIG. 5 is a view illustrating the power provision part when the doors according to an embodiment of the present disclosure are in the opened state.

With reference to FIGS. 3 to 5, the inner section 102-1 may be positioned to be closer to a side of a first curved line based on a radially inward direction than the first curved line. The first curved line may be defined as an imaginary curved line extending along a guide region 514 to be described below. The radially inward direction may be defined as a direction in which the first curved line is directed toward a center of curvature of the first curved line. In addition, a radially outward direction may be defined as a direction opposite to the radially inward direction. The inner sections 102-1 may include a first inner section 102-11 and a second inner section 102-12.

The first inner section 102-11 may define one end of the door guide hole 102. The second inner section 102-12 may define the other end of the door guide hole 102. The first inner section 102-11 and the second inner section 102-12 may be disposed to be spaced apart from each other in a direction in which the first curved line extends.

The outer section 102-2 may define the remaining part of the door guide hole 102 excluding the inner sections 102-1. The outer section 102-2 may be positioned to be closer to a side of the first curved line based on the radially outward direction than the first curved line. Two opposite ends of the outer section 102-2 may be respectively connected to the first inner section 102-11 and the second inner section 102-12. In addition, for example, the outer section 102-2, the first inner section 102-11, and the second inner section 102-12 may be integrated.

The tray guide hole 103 may be penetratively formed in the lower portion of the housing 100 in the upward/downward direction H. The tray guide hole 103 may guide the motion of the tray 200. The tray guide hole 103 may extend in a forward/rearward direction. The tray guide holes 103 may be provided as a plurality of tray guide holes 103. The plurality of tray guide holes 103 may be disposed to be spaced apart from one another in the leftward/rightward direction.

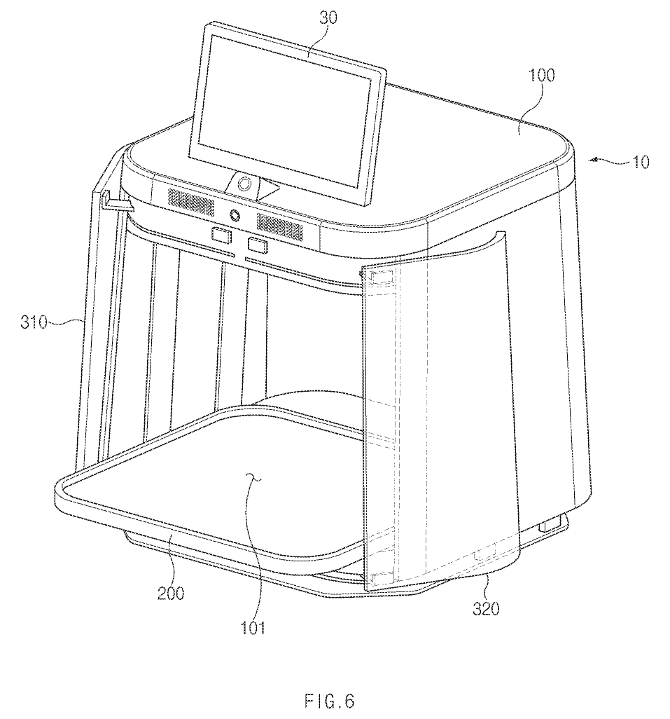

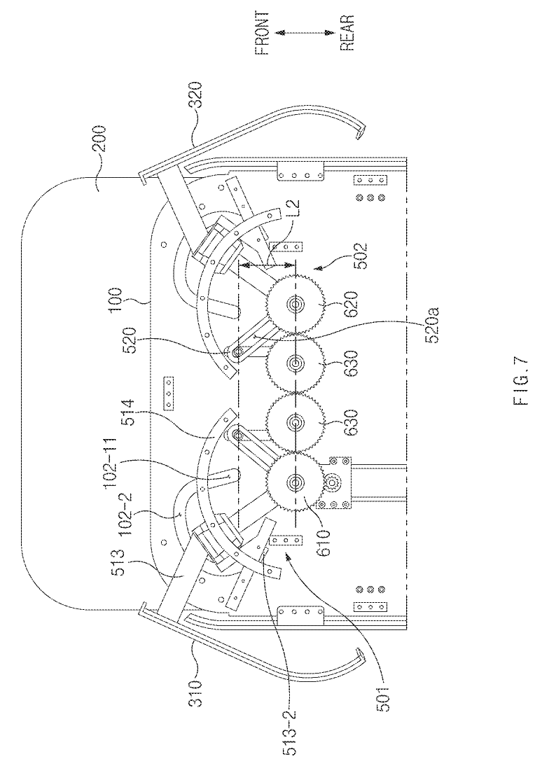

FIG. 6 is a perspective view of the cabin when the doors according to an embodiment of the present disclosure are in the opened state, and FIG. 7 is a bottom plan view of the cabin when the doors according to an embodiment of the present disclosure are in the opened state.

With reference to FIGS. 6 and 7, the item accommodated in the accommodation space 101 may be seated on the tray 200. The tray 200 may be moved relative to the housing 100 so that the tray 200 is unloaded from the accommodation space 101 or loaded into the accommodation space 101. A direction in which the tray 200 is unloaded from the accommodation space 101 may be referred to as an unloading direction, and a direction opposite to the unloading direction may be referred to as a loading direction. For example, the unloading direction may be the forward direction. For example, the loading direction may be the rearward direction. In other words, the tray 200 may be configured to be movable in the forward/rearward direction relative to the housing 100.

The door 300 may open the accommodation space 101 to the outside of the cabin 10 or close the accommodation space 101 from the outside of the cabin 10. The door 300 may be configured to be movable relative to the housing 100. A state in which the door 300 opens the accommodation space 101 to the outside may be referred to as the opened state. In addition, a state in which the door 300 closes the accommodation space 101 from the outside may be referred to as the closed state. The door 300 may move relative to the housing 100 between the opened state and the closed state.

For example, the door 300 may be made of a transparent material to ensure visibility of the accommodation space 101 when the accommodation space 101 is viewed from the outside. The doors 300 may be provided as a plurality of doors 300. The plurality of doors 300 may include a first door 310 and a second door 320.

The first door 310 may be rotatably connected to one side (e.g., a right side) of the housing 100 based on the leftward/rightward direction. The second door 320 may be rotatably connected to the other side (e.g., a left side) of the housing 100 based on the leftward/rightward direction. The first door 310 and the second door 320 may be disposed symmetrically with respect to the reference plane. In addition, the first door 310 and the second door 320 may move symmetrically with respect to the reference plane. For example, a route, along which the first door 310 moves relative to the housing 100, and a route, along which the second door 320 moves relative to the housing 100, may be formed symmetrically with respect to the reference plane.

The motor 400 may generate rotational power. For example, the motor 400 may refer to a rotary motor including a rotor, a stator, a shaft, and a housing. The motor 400 may be fixed to the lower portion of the housing 100. For example, the motor 400 may be provided as a single motor. In a detailed example, the cabin 10 according to an embodiment of the present disclosure may be configured such that the plurality of components (e.g., the tray 200, the door 300, the power provision part 500, and the power transmission part 600) are operated by the rotational power generated by the single motor 400. However, the embodiments of the present disclosure are not limited to this example. The motor 400 may be provided as a plurality of motors 400.

The power provision part 500 may receive the rotational power, which is generated by the motor 400, from the motor 400. The power provision part 500 may provide the received rotational power to the door 300 and the tray 200. For example, the door 300, which receives the power from the power provision part 500, may perform an opening/closing operation. In addition, the tray 200, which receives the power from the power provision part 500, may be operated to be loaded into the accommodation space or unloaded from the accommodation space. The power provision part 500 may be disposed on the lower portion of the housing 100. The power provision part 500 may include a door driving part 510, a power conversion part 520, and a tray driving part 530.

With reference back to FIG. 2, the door driving part 510 may provide power to the door 300. For example, the door driving part 510 may provide the door 300 with first rotational power that is any one part of the rotational power generated by the motor 400. The door driving part 510 may connect the motor 400 and the door 300. The door driving part 510 may include a first region 511, a second region 512, a third region 513, and the guide region 514.

With reference back to FIG. 3, one end of the first region 511 may rotate about a first rotation axis X1. In addition, the other end of the first region 511 may be configured to revolve around the first rotation axis X1. The first rotation axis X1 may be defined as an imaginary straight line passing through one end of the first region 511 and extending in a first direction. For example, the first direction may be the upward/downward direction H. For example, the first region 511 may be fixed to a first gear 610 and rotate together with the first gear 610 to be described below. The first region 511 may be referred to as a first link.

The second region 512 may be fixed to the first region 511. The second region 512 may receive power from the first region 511. For example, the second region 512 may be configured to move together with the first region 511. The second region 512 may extend in a second direction. The second direction may be defined as a direction intersecting a direction in which one end and the other end of the first region 511 are directed toward each other. In addition, for example, the second direction may be perpendicular to the upward/downward direction H.

For example, the second region 512 may have a rail shape. The second region 512 may guide the movement of the third region 513 in the second direction.

One end of the third region 513 may be fixed to the door 300. The other end of the third region 513 may be connected to the second region 512 and may be configured to be movable in the second direction. The third region 513 may receive power from the second region 512. For example, the third region 513 may be rotated about the first rotation axis X1 and rectilinearly moved in the second direction by the motion of the second region 512. The third region 513 may include a third-first region 513-1 and a third-second region 513-2.

The third-first region 513-1 may define one end of the third region 513. The third-first region 513-1 may extend in parallel with the second direction. The door 300 may be fixed to one end of the third-first region 513-1, and the other end of the third-first region 513-1 may be connected to one end of the third-second region 513-2.

The third-second region 513-2 may extend in a third direction from the other end of the third-first region 513-1. The third direction may be defined as a direction intersecting the second direction and the direction of the first rotation axis X1. For example, the third direction may be perpendicular to the second direction and the upward/downward direction H.

The other end of the third-second region 513-2 may be disposed to face the second region 512. The other end of the third-second region 513-2 may movably engage with the second region 512. The other end of the third-second region 513-2 may extend in the second direction and may be configured to be movable in the second direction relative to the second region 512. In addition, for example, the third-first region 513-1 and the third-second region 513-2 may be integrated.

The guide region 514 may guide the movement of the other end of the first region 511. The guide region 514 may have an arc shape extending along the first curved line. For example, the guide region 514 may have a rail shape that engages with the other end of the first region 511. The guide region 514 may be fixed to the lower portion of the housing 100.

The power conversion part 520 may convert second rotational power, which is another part of the rotational power, to rectilinear power. The power conversion part 520 may be connected to the motor 400. One end of the power conversion part 520 may rotate about the first rotation axis X1. In addition, the other end of the power conversion part 520 may revolve around the first rotation axis X1.

For example, one end of the power conversion part 520 may be fixed to the first gear 610. For example, one end of the first region 511, the power transmission part 600, and the first gear 610 may be connected to one another in the upward/downward direction H.

A long hole 520a may be formed through the power conversion part 520 in the upward/downward direction H and extend in a direction (long hole direction) in which two opposite ends of the power conversion part 520 are directed toward each other. The long hole direction may be defined as a direction intersecting the first direction and the forward/rearward direction. For example, the long hole direction may be perpendicular to the upward/downward direction H. A tray protrusion 532 formed on the tray driving part 530 may be inserted into the long hole 520a.

The tray protrusion 532 may be a protrusion having a shape protruding in the first direction (e.g., a downward direction). The tray protrusion 532 may be inserted into the tray guide hole 103. The tray protrusion 532 may be configured to be movable relative to the power conversion part 520 in the direction in which the long hole 520a extends in the state in which the tray protrusion 532 is inserted into the long hole 520a. In other words, the tray protrusion 532 may be inserted into the tray guide hole 103 and the long hole 520a.

For example, the power conversion part 520 may have a link shape that connects the first gear 610 and the tray driving part 530. The power conversion part 520 may be referred to as a power conversion link.

When one end of the power conversion part 520 rotates about the first rotation axis X1, the power conversion part 520 may provide the tray driving part 530 with rectilinear power that is power for moving the tray driving part 530 forward or rearward. When the tray driving part 530 moves forward or rearward, the tray protrusion 532 may move relative to the power conversion part 520 in the direction in which the long hole 520a extends.

With reference back to FIGS. 2 and 7, a spacing distance in the forward/rearward direction between one end of the power conversion part 520 and a rear end of the tray guide hole 103 may be referred to as a first distance L1, and a spacing distance in the forward/rearward direction between one end of the power transmission part 600 and a front end of the tray guide hole 103 may be referred to as a second distance L2. The first distance L1 and the second distance L2 may be different from each other. For example, the second distance L2 may be longer than the first distance L1.

Because the first distance L1 and the second distance L2 are different from each other as described above, a rectilinear movement speed of the tray driving part 530 may not be constant while the power conversion part 520 moves at a predetermined angular speed.

For example, the movement amount of the tray driving part 530 with respect to the rotation amount of the power conversion part 520 may increase as an angle of the power conversion part 520 with respect to the imaginary straight line extending in the leftward/rightward direction increases. In a detailed example, the movement amount of the tray driving part 530 with respect to the rotation amount of the power conversion part 520 may gradually increase while the power conversion part 520 rotates forward from the state in which the power conversion part 520 is oriented in parallel with the leftward/rightward direction.

The tray driving part 530 may move the tray 200 in the forward/rearward direction relative to the housing 100. The tray driving part 530 may be fixed to the tray 200 (e.g., fixed to a lower portion of the tray 200). The tray driving part 530 may move in the forward/rearward direction in the state in which the tray driving part 530 is inserted into the tray guide holes 103.

In addition, the power provision parts 500 may be provided as a plurality of power provision parts 500. The plurality of power provision parts 500 may include first and second power provision parts 501 and 502 disposed symmetrically with respect to the reference plane. For example, the first power provision part 501 may be disposed at a relatively left side, and the second power provision part 502 may be disposed at a relatively right side.

For example, the rotational power generated by the single motor 400 may be transmitted only to any one of the first power provision part 501 and the second power provision part 502. For example, in case that the rotational power generated by the motor 400 is transmitted to the first power provision part 501, the remaining power of the generated rotational power, which excludes the first rotational power and the second rotational power, may be transmitted to the power transmission part 600 and the second power provision part 502. Hereinafter, the description will be made on the assumption that the rotational power generated by the motor 400 is transmitted to the first power provision part 501.

The power transmission part 600 may transmit the rotational power, which is transmitted from the first power provision part 501, to the second power provision part 502. The power transmission part 600 may include the first gear 610, a second gear 620, and intermediate gears 630.

The first gear 610 may receive the rotational power from the motor 400. The first gear 610 may be configured to rotate about the first rotation axis X1. The first gear 610 may rotate the power conversion part 520 and the first region 511 of the first power provision part 501 about the first rotation axis X1.

The second gear 620 may receive the rotational power from the intermediate gear 630. The second gear 620 may rotate about a second rotation axis. The second rotation axis may be defined as an imaginary straight line spaced apart from the first rotation axis X1 in the leftward/rightward direction and extending in the upward/downward direction H.

The second gear 620 may rotate the power conversion part 520 and the first region 511 of the second power provision part 502 about the second rotation axis. For example, the power conversion part 520 and the first region 511 of the second power provision part 502 may be fixed to the second gear 620.

The intermediate gear 630 may be disposed between the first gear 610 and the second gear 620. The intermediate gear 630 may receive the rotational power from the first gear 610 and transmit the received rotational power to the second gear 620. The intermediate gears 630 may be provided as a plurality of intermediate gears 630.

The plurality of intermediate gears 630 may include a first intermediate gear and a second intermediate gear. The first intermediate gear may be a gear configured to engage with the first gear 610 and the second intermediate gear. The first intermediate gear may be disposed between the first gear 610 and the second intermediate gear based on the leftward/rightward direction. A gear ratio between the first intermediate gear and the first gear 610 may be equal to a gear ratio between the first intermediate gear and the second intermediate gear.

The second intermediate gear may be a gear configured to engage with the first intermediate gear and the second gear 620. The second intermediate gear may be disposed between the second intermediate gear and the second gear 620 based on the leftward/rightward direction. A gear ratio between the second intermediate gear and the second gear 620 may be equal to a gear ratio between the first intermediate gear and the first gear 610. The first gear 610, the second gear 620, and the plurality of intermediate gears may have the same size and shape.

Hereinafter, a route through which the rotational power generated by the motor 400 is transmitted will be described in detail.

The rotational power generated by the motor 400 may be transmitted to the first gear 610. The first gear 610 may transmit a part of the received rotational power to the first power provision part 501 and may transmit the remaining part of the received rotational power to the first intermediate gear. The first intermediate gear may transmit the received rotational power to the second intermediate gear. The second intermediate gear may transmit the received rotational power to the second gear 620. The second gear 620 may transmit the received rotational power to the second power provision part 502.

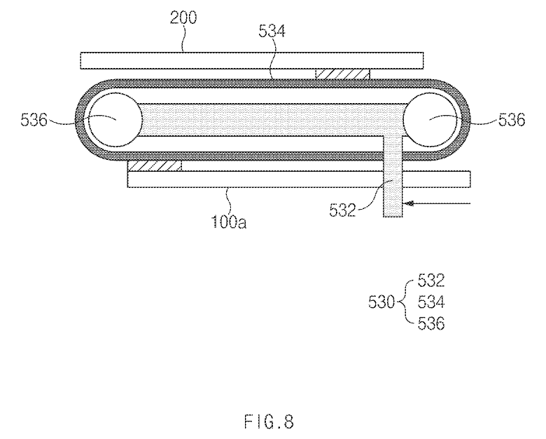

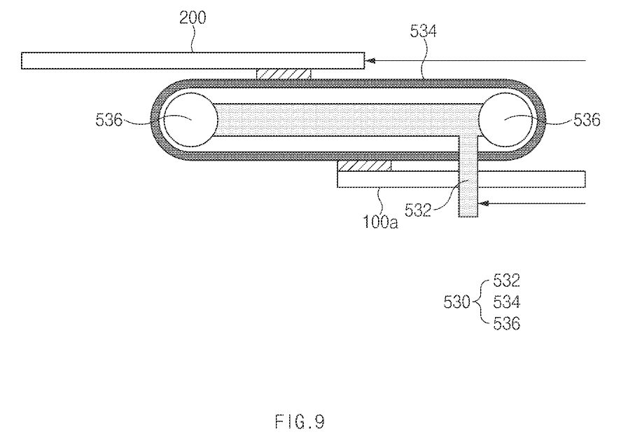

FIG. 8 is a cross-sectional view for explaining coupling structures between the tray, the tray driving part, and the housing according to an embodiment of the present disclosure, i.e., a view illustrating a state made before the tray driving part is moved forward. FIG. 9 is a cross-sectional view for explaining the coupling structures between the tray, the tray driving part, and the housing according to an embodiment of the present disclosure, i.e., a view illustrating a state made after the tray driving part is moved forward.

Meanwhile, the mobile body according to embodiments of the present disclosure may further include a feature in which a distance by which the tray 200 moves in the forward/rearward direction is longer than a distance by which the tray driving part 530 moves in the forward/rearward direction. In this case, the tray 200 may move at a higher speed in the forward/rearward direction.

The tray driving part 530 according to embodiments of the present disclosure may further include a belt member 534 having a cross-sectional shape of a closed curve and rotary members 536 tightly attached to the belt member 534 and configured to be rotatable. More specifically, FIGS. 8 and 9 illustrate that the belt member 534 has a shape extending in the forward/rearward direction of the mobile body and bent about the two rotary members 536 spaced apart from each other in the forward/rearward direction.

In this case, one side of the belt member 534 may be fixed to the housing 100, and the other side of the belt member 534 may be fixed to the tray 200. For example, the housing 100 may include a lower plate 110 provided in a region below the mobile body and the cabin and provided to face the tray 200 in the upward/downward direction. One side of the belt member 534 may be fixed to the lower plate 110. Meanwhile, the door guide hole 102 and the tray guide hole 103 may be formed in the lower plate 110. FIGS. 8 and 9 illustrate that the lower plate 110 is provided below the tray 200 and the tray driving part 530, and the lower plate 110 is provided to face the tray 200 in the upward/downward direction with the tray driving part 530 interposed therebetween. In this case, one side of the belt member 534 may be formed in an upper region based on the rotary member 536, and the other side of the belt member 534 may be formed in a lower region based on the rotary member 536.

According to embodiments of the present disclosure, in case that the tray driving part 530 is moved forward by the operation of the motor in the state in which the tray driving part 530 is positioned at a rear side (i.e., before the tray is moved forward) as illustrated in FIG. 8, the tray driving part 530 needs to be moved forward in a state in which a portion of the belt member 534, which is fixed to the lower plate 110, is not moved in the forward/rearward direction. Therefore, the tray 200 may be moved forward by a distance made by adding up a distance by which the tray driving part 530 is moved forward and a distance by which the upper region of the belt member 534 is moved forward.

All the constituent elements, which constitute the embodiments of the present disclosure, may be integrally coupled or operate by being combined, but the present disclosure is not necessarily limited to the embodiments. That is, one or more of the constituent elements may be selectively combined and operated within the embodiments of the present disclosure. In addition, unless explicitly described to the contrary, the words "comprise," "include," or "have" and variations such as "comprises," "comprising," "includes," "including," "has," or "having," should be understood to imply the inclusion of stated elements but not the exclusion of any other elements. Unless otherwise defined, all terms including technical or scientific terms may have the same meaning as commonly understood by those skilled in the art to which the present disclosure pertains. The terms such as those defined in a commonly used dictionary may be interpreted as having meanings consistent with meanings in the context of related technologies and may not be interpreted as having ideal or excessively formal meanings unless explicitly defined in the present disclosure.

The above description is simply given to illustratively describe the technical spirit of the present disclosure, and those skilled in the art to which the present disclosure pertains will appreciate that various changes and modifications are possible without departing from the essential characteristic of the present disclosure. Therefore, the embodiments disclosed in the present disclosure are provided for illustrative purposes only but are not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

What is claimed is:

1. A cabin comprising:
a housing having an accommodation space capable of accommodating an object therein;
a tray configured to be loaded into or unloaded from the accommodation space, the tray being configured such that the object is seated on the tray;
a door configured to open the accommodation space to an outside of the housing or close the accommodation space from the outside of the housing;
a motor fixed to the housing and configured to generate rotational power; and a power provision part configured to receive the rotational power from the motor and transmit power to the door and the tray, the power being required for an operation of opening or closing the door and for an operation of loading or unloading the tray, wherein the power provision part comprises:
a door driving part configured to connect the motor and the door and transmit first rotational power to the door, the first rotational power being a first part of the rotational power;
a power conversion part connected to the motor and configured to convert second rotational power into rectilinear power, the second rotational power being a second part of the rotational power; and
a tray driving part configured to connect the power conversion part and the tray and transmit the rectilinear power, which is transmitted from the power conversion part, to the tray.

2. The cabin of claim 1, wherein the door driving part comprises:
a first region having a first end configured to rotate about a first rotation axis and a second end configured to revolve around the first rotation axis, wherein the first rotation axis is an imaginary straight line extending in a first direction; a second region extending in a second direction that is a direction intersecting a direction in which the first end of the first region and the second end of the first region are directed toward each other, the second region being fixed to the first region; and a third region having a first end fixed to the door and a second end connected to the second region and configured to be movable in the second direction.

3. The cabin of claim 2, wherein:
the first direction is an upward/downward direction;
the third region intersects a reference straight line in a case in which a lower portion of the cabin is viewed in parallel with the upward/downward direction, wherein the reference straight line is an imaginary straight line passing through the first rotation axis and extending in the second direction;
a door guide hole is disposed in a lower portion of the housing and is configured to guide a movement of the second end of the third region;
an imaginary curved line extending along a route along which the second end of the first region is movable is a first curved line; and
the first curved line has an arc shape having a center and a predetermined radius, wherein the center is the first rotation axis.

4. The cabin of claim 3, wherein the door guide hole comprises:
an inner section positioned to be closer to a side of the first curved line based on a radially inward direction than the first curved line; and
an outer section positioned to be closer to a side of the first curved line based on a radially outward direction than the first curved line.

5. The cabin of claim 4, wherein the inner section comprises a plurality of inner sections comprising:
a first inner section connected to a first end of the outer section; and a second inner section connected to a second end of the outer section.

6. The cabin of claim 4, wherein the third region comprises:
a third-first region configured to define the first end of the third region and extending in the second direction; and a third-second region extending from the third-first region in a third direction that is a direction intersecting the second direction and a direction of the first rotation axis.

7. The cabin of claim 6, wherein a region of the third-second region facing the second region extends in the second direction so as to be movable in the second direction relative to the second region and engages with the second region.

8. The cabin of claim 1, wherein:
the tray driving part is fixed to the tray and configured to move relative to the housing in a loading/unloading direction of the tray;
the door driving part comprises a first region configured to be rotated about a first rotation axis by the first rotational power, wherein the first rotation axis is an imaginary straight line extending in a first direction; and
the power conversion part is configured to be rotated about the first rotation axis by the second rotational power.

9. The cabin of claim 8, further comprising:
a tray protrusion disposed on the tray driving part and having a shape protruding in the first direction; and
a long hole penetratively disposed in the power conversion part in the first direction and extending in a long hole direction intersecting the first direction and the loading/unloading direction, wherein the tray protrusion is inserted into the long hole.

10. The cabin of claim 9, further comprising a tray guide hole disposed in the housing and configured to guide a movement of the tray driving part in the loading/unloading direction.

11. The cabin of claim 10, wherein:
a first end of the power conversion part is configured to rotate about the first rotation axis;
a second end of the power conversion part is configured to revolve around the first rotation axis;
a direction of the loading/unloading direction in which the tray is unloaded from the accommodation space is an unloading direction; a direction opposite to the unloading direction is a loading direction;
the power provision part comprises a first power provision part and a second power provision part;
a power transmission part is configured to transmit a part of the rotational power transmitted to the first power provision part or the second power provision part to the other of the first power provision part and the second power provision part; and
a first spacing distance in the loading/unloading direction between the first end of the power conversion part and a first end of the tray guide hole based on the loading direction and a second spacing distance in the loading/unloading direction between a first end of the power transmission part and a second end of the tray guide hole based on the unloading direction are different from each other.

12. The cabin of claim 11, wherein the second spacing distance is longer than the first spacing distance.

13. The cabin of claim 1, wherein:
a reference plane is an imaginary plane passing through a center of the accommodation space and perpendicular to a reference direction perpendicular to an upward/downward direction and a direction in which the tray is loaded or unloaded;
the power provision part comprises a first power provision part and a second power provision part disposed symmetrically with respect to the reference plane; and
the rotational power generated by the motor is transmitted to either the first power provision part or the second power provision part.

14. The cabin of claim 13, wherein the cabin further comprises a power transmission part configured to transmit a part of the rotational power transmitted to either the first power provision part or the second power provision part to the other of the first power provision part and the second power provision part.

15. The cabin of claim 14, wherein the power transmission part comprises:
a first gear configured to be rotated about a first rotation axis by the motor and fixed to the door driving part and the power conversion part disposed in the first power provision part;
a second gear fixed to the door driving part and the power conversion part disposed in the second power provision part; and
an intermediate gear configured to engage with the first gear and the second gear to transmit rotational power of the first gear to the second gear.

16. A cabin comprising:
a housing having an accommodation space capable of accommodating an object therein;
a tray configured to be loaded into or unloaded from the accommodation space, the tray being configured such that the object is seated on the tray;
a door configured to open the accommodation space to an outside of the housing or close the accommodation space from the outside of the housing;
a motor fixed to the housing and configured to generate rotational power; and a power provision part configured to receive the rotational power from the motor and transmit power to the door and the tray, the power being required for an operation of opening or closing the door and for an operation of loading or unloading the tray, wherein the power provision part comprises:
a door driving part configured to connect the motor and the door and transmit first rotational power to the door, the first rotational power being a first part of the rotational power;
a power conversion part connected to the motor and configured to convert second rotational power into rectilinear power, the second rotational power being a second part of the rotational power; and
a tray driving part configured to connect the power conversion part and the tray and transmit the rectilinear power, which is transmitted from the power conversion part, to the tray, wherein the tray driving part further comprises:
a belt member, wherein a first side of the belt member is fixed to the housing and a second side of the belt member is fixed to the tray; and
a rotary member tightly attached to the belt member and configured to be rotatable.

17. The cabin of claim 16, wherein:
the housing comprises a lower plate disposed in a lower region of the cabin;
the lower plate is disposed to face the tray in an upward/downward direction; and
the first side of the belt member is fixed to the lower plate.

18. The cabin of claim 17, wherein:
the first side of the belt member is disposed in an upper region based on the rotary member; and
the second side of the belt member is disposed in a lower region based on the rotary member.

19. A mobile body comprising:
a cabin comprising:
a housing having an accommodation space capable of accommodating an object therein;
a tray configured to be loaded into or unloaded from the accommodation space, the tray being configured such that the object is seated on the tray;
a door configured to open the accommodation space to an outside of the housing or close the accommodation space from the outside of the housing;
a motor fixed to the housing and configured to generate rotational power; and a power provision part configured to receive the rotational power from the motor and transmit power to the door and the tray, the power being required for an operation of opening or closing the door and for an operation of loading or unloading the tray, wherein the power provision part comprises:
a door driving part configured to connect the motor and the door and transmit first rotational power to the door, the first rotational power being a first part of the rotational power;
a power conversion part connected to the motor and configured to convert second rotational power into rectilinear power, the second rotational power being a second part of the rotational power; and
a tray driving part configured to connect the power conversion part and the tray and transmit the rectilinear power, which is transmitted from the power conversion part, to the tray; and
a movable part configured to move the cabin.

20. The mobile body of claim 19, wherein the door driving part comprises:
a first region having a first end configured to rotate about a first rotation axis and a second end configured to revolve around the first rotation axis, wherein the first rotation axis is an imaginary straight line extending in a first direction;
a second region extending in a second direction that is a direction intersecting a direction in which the first end of the first region and the second end of the first region are directed toward each other, the second region being fixed to the first region; and
a third region having a first end fixed to the door and a second end connected to the second region and configured to be movable in the second direction.
